(19) United States
(12) Patent Application Publication
(10) Pub. No.: US 2006/0244683 A1
(43) Pub. Date: Nov. 2, 2006

(54) Method of driving plasma display panel

(75) Inventors: Takeru Okada, Chuo-shi (JP); Yoichi Shintani, Chuo-shi (JP); Tasuku Ishibashi, Chuo-shi (JP); Masaki Yoshinari, Chuo-shi (JP); Yoichi Okumura, Chuo-shi (JP); Hirokazu Hashikawa, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/377,376

(22) Filed: Mar. 17, 2006

(30) Foreign Application Priority Data
Mar. 18, 2005 (JP) 2005-079447

(51) Int. Cl. G09G 3/28

(52) U.S. Cl. 345/60

(57) ABSTRACT

A method for driving a plasma display panel having column electrodes formed on a front substrate side together with row electrodes. Wall charge adjusting pulses having the same polarity as a sustain pulse are simultaneously applied to respective row electrodes formed in pair for a predetermined period after an addressing stage terminates and before a sustain stage starts in each sub-field.

### BACKGROUND OF THE INVENTION

1. Field of the Invention

The present invention relates to a method of driving a plasma display panel.

2. Description of the Related Art

As a display panel of matrix display scheme, there is known an AC (AC discharge) type plasma display panel. The AC-type plasma display panel comprises a plurality of column electrodes (address electrodes), and a plurality of row electrode pairs which are arranged orthogonal to the column electrodes and each of which forms one scan line. These row electrode pairs and column electrodes are covered with a dielectric layer through which a discharge space opposes. A discharge cell corresponding to one pixel is formed at an intersection of a row electrode pair with a column electrode.

As a method of displaying a halftone image on such a plasma display panel, a so-called sub-field method is known, where one field period is divided into N sub-fields in which light is emitted for a time corresponding to a weight for each bit digit of N-bit pixel data. FIG. 1 is a diagram showing a light emission driving format according to the sub-field method in one field period.

In the example shown in FIG. 1, one field period is divided into six sub-fields SF1, SF2, . . . , SF6 for driving light emission on the assumption that supplied pixel data has a length of six bits. 64-step gradation can be accomplished for one field of image by cycling through light emission based on these six sub-fields.

Each sub-field is made up of an addressing period Wc, and a sustain period Ic. However, in the first sub-field, a reset period Rc is provided before the addressing period Wc. In the reset period Rc, all discharge cells of the plasma display panel are simultaneously excited to discharge (reset discharge) to uniformly form wall charges in all the discharge cells. In the next addressing period Wc, a selective erasure discharge is excited in accordance with pixel data for each discharge cell. In this event, the wall charge extinguishes in those discharge cells in which the erasure discharge has been performed, causing the discharge cells to become “unlit cells.” On the other hand, those discharge cells in which no erasure discharge has been performed are “lit cells” because the wall charges still remain therein. In the sustain period Ic, only the lit cells are forced to continue a discharge light emission state for a time corresponding to a weight for each sub-field. In this way, in the respective sub-fields SF1-SF6, the light emission is sustained in a light emission period ratio of 1:2:4:8:16:32 in order. A driving method which involves forming wall charges in all display cells at the beginning of the sub-field SF1, and selectively erasing the wall charge formed in each display cell in the addressing period Wc of the subsequent sub-fields SF1-SF6 in the foregoing manner is called a selective erasure addressing method.

Generally, in the plasma display panel, a plurality of row electrode pairs are arranged in parallel with each other to extend in the row direction on a front glass substrate, while a plurality of column electrodes are arranged to extend in the column direction on a back substrate.

FIG. 2 shows a chart indicative of times at which a variety of driving pulses are applied to row electrodes X, Y and a column electrode D within one discharge cell of a plasma display panel which has the column electrodes arranged on the back substrate in the addressing period and sustain period. In the addressing period, pixel data pulses DP for one row corresponding to an input video image are sequentially applied to the plurality of column electrodes D, a scan pulse SP is generated when each pixel data pulse DP is applied, and the scan pulse SP is sequentially applied to the row electrodes Yi. In this event, as the scan pulse is applied to one row electrode to another, a discharge (selective erasure discharge) occurs only in a discharge cell at an intersection with a column which has been applied with a high-voltage pixel data pulse to erase the wall charge. In this way, a discharge cell, which has been initialized to a “lit cell” state in the reset period, transitions to an “unlit cell.” On the other hand, no selective erasure discharge is produced in a discharge cell formed at an intersection of a row and a column which were applied with a low-voltage pixel data pulse though the scan pulse SP was applied, so that such a discharge cell is held in the state initialized in the reset period, i.e., a “lit cell” state.

In the sustain state, a sustain pulse IP_{X} is repeatedly applied to the row electrodes, and a sustain pulse IP_{Y} is repeatedly applied to the row electrodes Y at a time point shifted from that of the sustain pulse IP_{X}. For each time the sustain pulses IP_{X}, IP_{Y} are applied, a sustain discharge occurs between the row electrodes in a discharge cell which is in the “lit cell” state. The number of times the sustain pulses IP_{X} and IP_{Y} are applied in each sub-field is set in accordance with a weight for each sub-field, as shown in FIG. 1.

FIG. 2 shows a change in charges on the row electrodes X, Y and column electrode D within a discharge cell caused by discharges thereby. As a sustain discharge is produced by a discharge current which flows in a direction indicated by an arrow between the row electrode X and the row electrode Y by the sustain pulse IP_{X} applied to the row electrode X in the sustain period of a sub-field SFi-1, a negative wall charge − is formed on the row electrode X, while a positive wall charge + is formed on the row electrode Y. Next, a sustain discharge is produced by a discharge current flowing in a direction indicated by an arrow between the row electrode X and the row electrode Y by the sustain pulse IP_{Y} applied to the row electrode Y. This causes a wall charge to be formed on the row electrode X, and a negative wall charge − to be formed on the row electrode Y. In this state, the sub-field SFi-1 terminates, followed by the start of the next sub-field SFi. Assume that a positive charge + has been formed on the column electrode D in the sub-field SFi-1.

In the addressing period of the sub-field SFi, as a scan pulse is applied to the row electrode Y at the same time a high-voltage pixel data pulse is applied to the column electrode D, a selective erasure discharge occurs with a discharge current flowing in a direction indicated by an arrow between the column electrode D and the row electrode Y. Thus, this discharge cell changes to an “unlit cell.” At the end of the addressing period, positive wall charges + are formed on both the row electrodes X and Y, while a negative wall charge − is formed on the column electrode D. Therefore, even if the sustain pulse IP_{Y} is applied to the row electrode in the subsequent sustain period of the sub-field SFi, or even if the sustain pulse IP_{X} is applied to the row electrode X, no sustain discharge will occur between the row electrode Y and the row electrode X.

Another known plasma display panel includes a co-planar configuration panel which has a plurality of row electrode pairs arranged in parallel with each other to extend in the row direction on a front glass substrate, a plurality of column electrodes arranged in parallel in the column direction on the front glass substrate, and protrusions of the column electrodes in a discharge gap between the row electrode pairs of the respective discharge cells, other than the panel which has the column electrodes arranged on a back substrate.

As shown in FIG. 3, when a driving method based on the selective erasure address method is applied to a plasma display panel which has column electrodes arranged on the front glass substrate together with the row electrode pairs, the charges on the row electrodes X, Y and column electrode D change in the discharge cell in the same manner as the plasma display panel having the column electrodes arranged on the back substrate, shown in FIG. 2, until the end of the addressing period of the sub-field SFi. However, in a discharge cell which is set to an “unlit cell” by a selective erasure discharge produced during the addressing period of the sub-field SFi, an erroneous discharge can occur between the row electrode Y and the column electrode D by a first sustain pulse IP_{Y} in the subsequent sustain period, disadvantageously causing the discharge cell to enter a lit cell state due to inverted states of the wall charges on the row electrode Y and column electrode D.

### SUMMARY OF THE INVENTION

It is an object of the present invention to provide a driving method which is capable of preventing erroneous discharges even if a selective erasure addressing method is applied to a plasma display panel which has both column electrodes and row electrodes arranged on a front substrate.

A plasma display panel driving method of the present invention is a method of driving a plasma display panel in accordance with an image signal, the plasma display panel having a pair of substrates opposing across a discharge space, a plurality of row electrode pairs corresponding to display lines and extending in a row direction and a plurality of column electrodes disposed between the pair of substrates, to respectively form discharge cells in portions of the discharge space opposing regions surrounded by row electrodes constituting the respective row electrode pairs and the column electrodes adjacent to each other, at least one of the row electrodes constituting each of the row electrode pairs and each of the column electrodes being formed on one of the pair of substrates, wherein: one field display period of the image signal is divided into a plurality of sub-fields, the method comprising the steps of: executing in each of the sub-fields, an addressing stage for sequentially applying a scan pulse to one row electrodes of the row electrode pairs, and applying pixel data pulses corresponding to the image signal to the column electrodes to produce a selective erasure discharge for setting each of the discharge cells to one of a lit cell state and an unlit cell state, and a sustain stage for applying a sustain pulse to the row electrodes constituting each of the row electrode pairs a number of times corresponding to a weight for the sub-field to produce a sustain discharge only in the discharge cell in the lit cell state; and simultaneously applying wall charge adjusting pulses having a same polarity as the sustain pulse to the row electrodes formed in pair for a predetermined period in each of the sub-fields after the addressing stage terminates and before the sustain stage starts.

### BRIEF DESCRIPTION OF THE DRAWINGS

FIG. 1 is a diagram showing an exemplary light emission driving sequence employed in a conventional plasma display device;

FIG. 2 is a diagram showing times at which a variety of driving pulses are applied to a PDP which has column electrodes on a back substrate, and a change in charges on electrodes;

FIG. 3 is a diagram showing times at which a variety of driving pulses are applied to a PDP which has column electrodes arranged on a front glass substrate together with row electrode pairs, and a change in charges on electrodes;

FIG. 4 is a diagram generally showing the configuration of a plasma display device according to the present invention;

FIG. 5 is a front view schematically illustrating the internal structure of the PDP in FIG. 4;

FIG. 6 is a cross-sectional view taken along a V1-V1 line in FIG. 5;

FIG. 7 is a cross-sectional view taken along a line V2-V2 in FIG. 5;

FIG. 8 is a cross-sectional view taken along a W-W line in FIG. 5;

FIG. 9 is a diagram showing an example of a light emission driving sequence employed by the device of FIG. 4;

FIG. 10 is a diagram showing times at which a variety of driving pulses are applied to the PDP in accordance with the light emission driving sequence shown in FIG. 9, and a change in charges on electrodes;

FIG. 11 is a diagram showing times at which a variety of driving pulses are applied to the PD, and a change in charges on the electrodes in another embodiment of the present invention;

FIG. 12 is a diagram showing times at which a variety of driving pulses are applied to the PD, and a change in charges on the electrodes in another embodiment of the present invention;

FIG. 13 is a diagram showing times at which a variety of driving pulses are applied to the PD, and a change in charges on the electrodes in another embodiment of the present invention; and

FIG. 14 is a front view schematically showing the internal structure of another PDP which can be used in the device of FIG. 4.

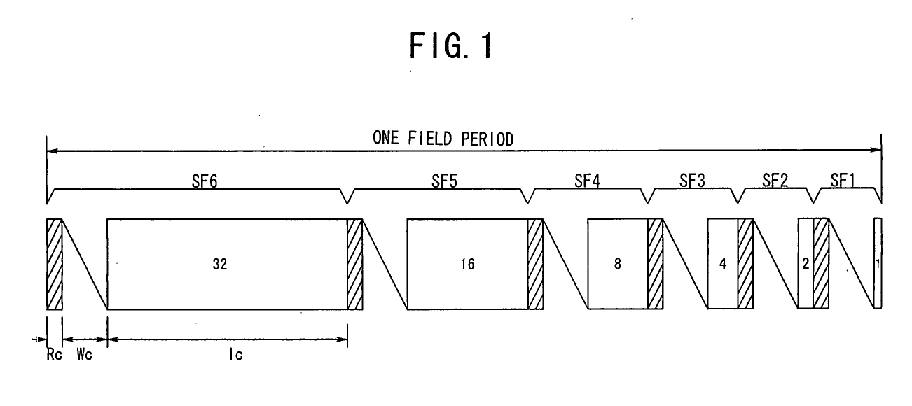

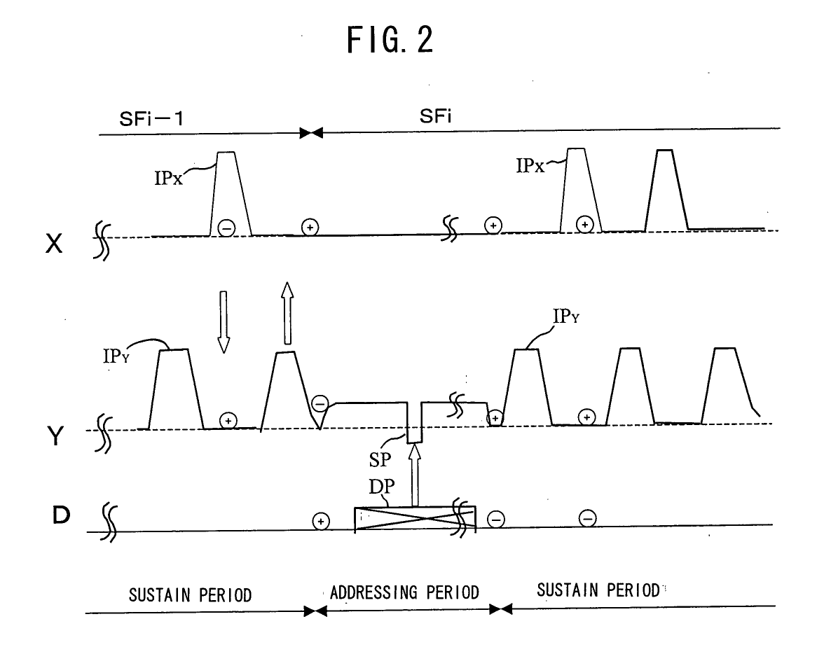

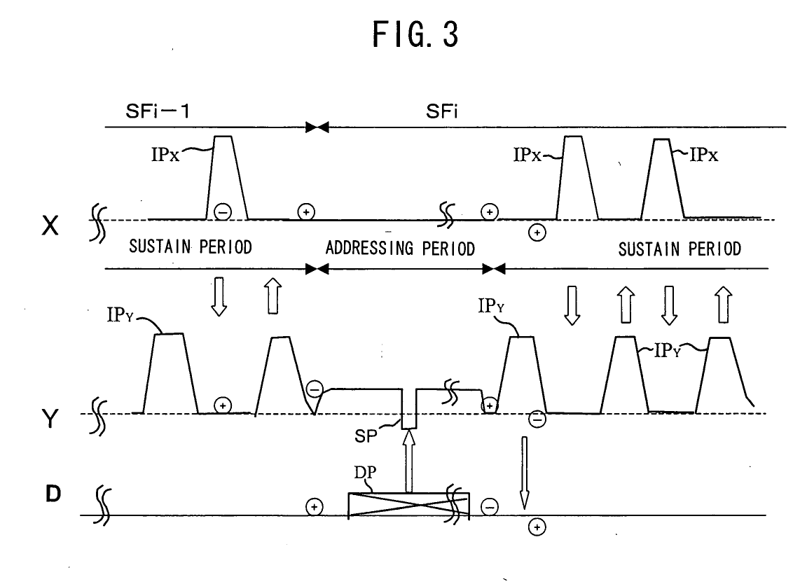

### DETAILED DESCRIPTION OF THE INVENTION

In the following, embodiments of the present invention will be described in detail with reference to the drawings.

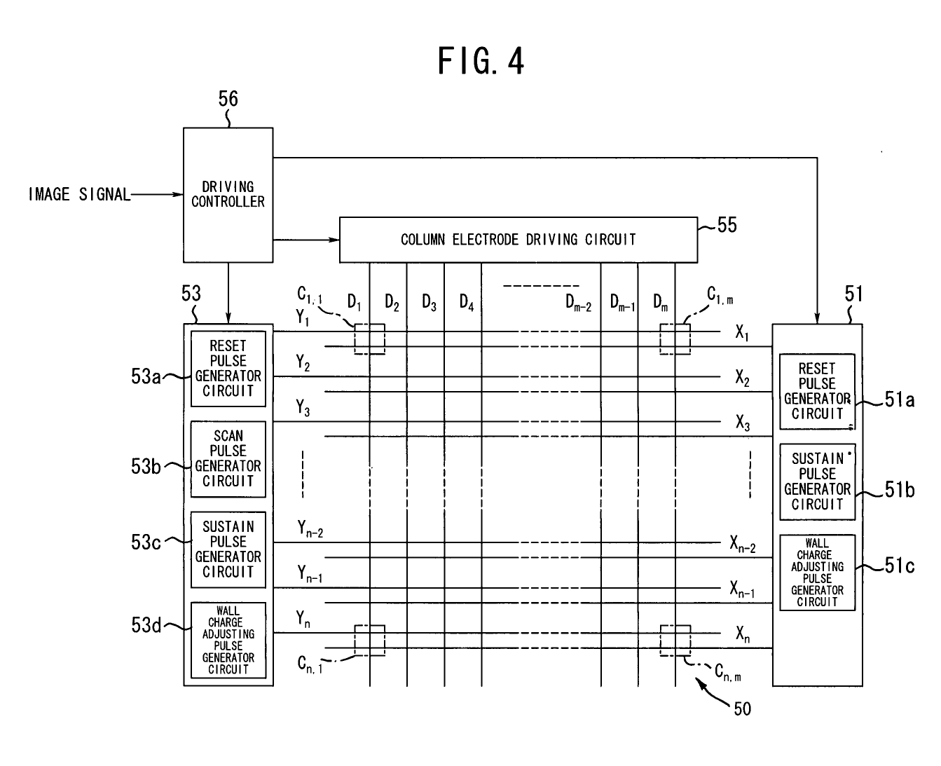

FIG. 4 is a diagram generally showing the configuration of a plasma display device according to the present invention.

As shown in FIG. 4, the plasma display device comprises a PDP 50 as a plasma display panel; an X-electrode driving circuit 51; a Y-electrode driving circuit 53; a column electrode driving driver 55; and a driving control circuit 56.

The PDP 50 is formed with column electrodes D₁-Dₘ respectively extending in a vertical direction of a two-dimensional display screen, and row electrodes X₁-Xₙ and row electrodes Y₁-Yₙ respectively extending in the horizontal direction of the two-dimensional display screen. In this event, row electrode pairs (Y₁, X₁), (Y₂, X₂), (Y₃, X₃), . . . , (Yₙ, Xₙ), which form pairs with adjacent ones to each other, form a first display line to an n-th display line on the PDP 50. At the intersection of each display line with each of the column electrodes D₁-Dₘ (an area surrounded by a one-dot chain line in FIG. 4), a display cell PC is formed to serve as a pixel. In other words, on the PDP 50, display cells C_{1,1}-C_{1,m} belonging to the first display line, display cells C_{2,1}-C_{2,m} belonging to the second display line, . . . , display cells C_{n,1}-C_{n,m} belonging to the n-th display line are arranged in a matrix form.

Each of the column electrodes D₁-Dₘ of the PDP 50 is connected to the column electrode driving circuit 55, each of the row electrodes X₁-Xₙ is connected to the X-row electrode driving circuit 51, and each of the row electrodes Y₁-Yₙ is connected to the Y-row electrode driving circuit 53.

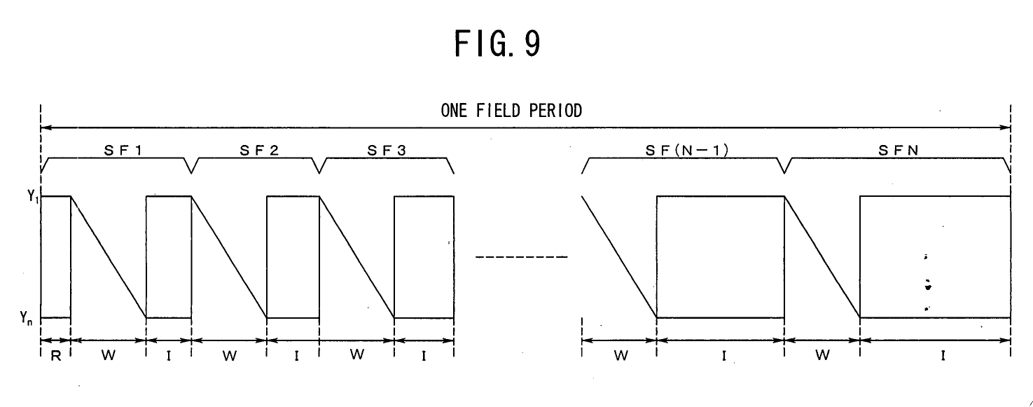

The driving control circuit 56 supplies each of the X-electrode driver 51, Y-electrode driver 53, and address driver 55 with a variety of control signals for driving the PDP 50 having the foregoing structure in accordance with a light emission driving sequence which employs a sub-field method (sub-frame method) as shown in FIG. 9, later described. The X-electrode driver 51, Y-electrode driver 53, and address driver 55 generate a variety of driving pulses (later described) for driving the PDP 50 in accordance with the light emission driving sequence shown in FIG. 9, and supplies the generated pulses to the PDP 50. The X-row electrode driving circuit 51 comprises a reset pulse generator circuit 51a, a sustain pulse generator circuit 51b, and a wall charge adjusting pulse generator circuit 51c. The Y-row electrode driving circuit 53 comprises a reset pulse generator circuit 53a, a scan pulse generator circuit 53b, a sustain pulse generator circuit 53c, and a wall charge adjusting pulse generator circuit 53d. The reset pulse generator circuits 51a, 53a, sustain pulse generator circuit 51b, scan pulse generator circuit 53b, and wall charge adjusting pulse generator circuits 51c, 53c generate pulses, as will be later described.

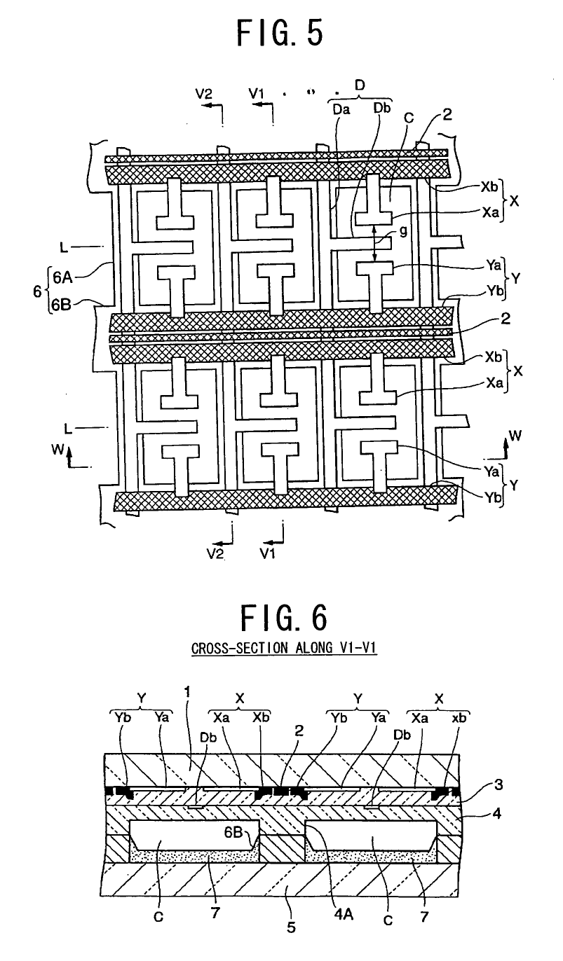

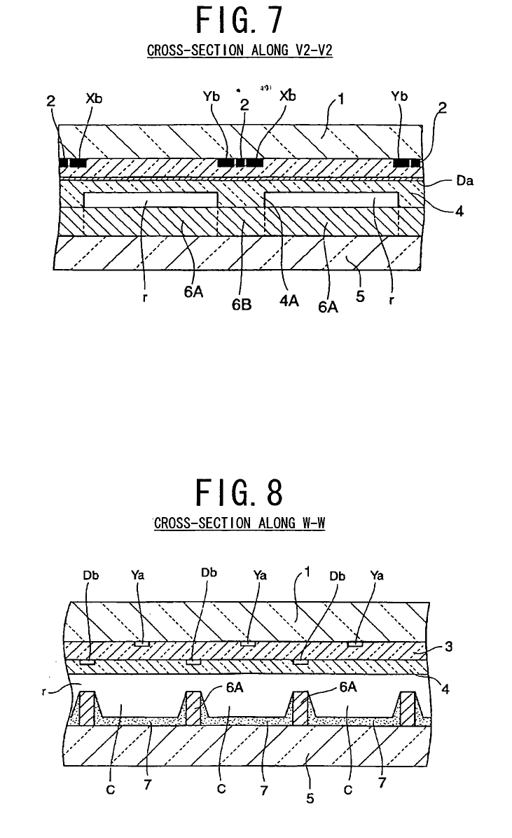

FIGS. 5 to 8 show an example of the PDP 50, where FIG. 5 is a front view schematically showing the PDP in this example; FIG. 6 is a cross-sectional view taken along a V1-V1 line in FIG. 5; FIG. 7 is a cross-sectional view taken along a V2-V2 line in FIG. 5; and FIG. 8 is a cross-sectional view along a line W-W in FIG. 8.

In these FIGS. 5 to 8, a plurality of electrode pairs (X, Y) are arranged on the front glass substrate 1, which forms a display plane, in parallel to extend in the row direction (horizontal direction in FIG. 5) of the front glass substrate 1.

The row electrode X comprises a transparent electrode Xa formed in a T-shape and made of a transparent conductive film such as ITO, and a bus electrode Xb made of a black or a dark metal film, extending in the row direction of the front glass substrate 1, and connected to a narrow proximal end of the transparent electrode Xa.

Likewise, the row electrode Y comprises a transparent electrode Ya formed in a T-shape and made of a transparent conductive film such as ITO, and a bus electrode Yb made of a black or a dark metal film, extending in the row direction of the front glass substrate 1, and connected to a narrow proximal end of the transparent electrode Ya.

These row electrodes X, Y are alternately arranged in the column direction (vertical direction in FIG. 5) on the front glass substrate 1, where the respective transparent electrodes Xa, Ya, arranged in parallel along the bus electrodes Xb, Yb extend toward the counterpart row electrode, formed in pair with each other, and wider leading ends of the transparent electrodes Xa, Ya oppose across the discharge gap g which has a certain spacing. One display line L of the panel is made up of each row electrode pair (X, Y).

On the back surface of the front glass substrate 1, a black or a dark light absorbing layer (light shielding layer) 2 is formed between the bus electrodes Xb, Yb, in parallel with each other, of adjacent row electrode pairs (X, Y) in the column direction to extend in the row direction along the bus electrodes Xb, Yb.

A first dielectric layer 3 is formed on the back surface of the front glass substrate 1 to cover the row electrode pairs (X, Y) and light absorbing layer 2.

On the back surface side of the first dielectric layer 3, column electrode bodies Da, which form part of the column electrodes D, are arranged in parallel with a predetermined spacing defined therebetween, such that they extend in a direction orthogonal to the row electrode pairs (X, Y) (column direction) at positions which oppose intermediate positions of the respective transparent electrodes Xa, Xb which are arranged at equal intervals in the row direction along bus electrodes Xb, Yb of the row electrodes X, Y.

On the back surface side of the first dielectric layer 3, a column electrode discharge portion Db, which forms part of the column electrode D, is integrally formed in the row direction from one side of each column electrode body Da for each display line L, such that its leading end is positioned at a position which opposes an intermediate position of the discharge gap g between the transparent electrodes Xa and Ya of each electrode pair (X, Y).

A second dielectric layer 4 is formed on the back surface of the first dielectric layer 3 to cover the column electrode body Da and column electrode discharge portion Db of this column electrode D.

On the back surface side of the second dielectric layer 4, a raised dielectric layer 4A projecting toward the back surface of the second dielectric layer is formed at a position opposing the light absorbing layer 2 positioned between the bus electrodes Xb, Yb of row electrode pairs (X, Y) adjacent to each other, to extend in the row direction along the bus electrodes Xb, Yb. Further, a protection layer made of MgO, not shown, is formed on the back surface sides of the second dielectric layer 4 and raised dielectric layer 4a.

On the other hand, on the display surface of the back glass substrate 5 opposing the front glass substrate 1 across a discharge space, gridded partitions 6 are formed of vertical walls 6A formed at positions opposing the column electrode bodies Da on the front glass substrate 1 side to respectively extend in the column direction, and horizontal walls 6B formed at positions opposing the bus electrodes Xb, Yb positioned back-to-back of the row electrode pairs (X, Y) adjacent to each other and the light absorbing layer 2 positioned therebetween to extend in the row direction, respectively, and the discharge space between the front glass substrate 1 and the back glass substrate 5 is partitioned into portions opposing the paired transparent electrodes Xa, Ya in each row electrode pair (X, Y) to form respective rectangular discharge cells C.

The surface of the vertical wall 6A of this partition 6 on the display side surface is not in contact with the protection layer which covers the raised dielectric layer 4A (see FIGS. 7 and 8), and a gap r is formed therebetween, but the display side surface of the horizontal wall 6B is in contact with a portion of the protection layer which covers the raised dielectric layer 4A to close between the adjacent discharge cells C in the column direction, respectively (see FIG. 6).

On the side surfaces of the vertical walls 6A and horizontal walls 6B of the partitions 6 facing the discharge cells C, and the surface of the back glass substrate 5, a fluorescent material layer 7 is formed to cover all of these five surfaces, and the colors of the fluorescent material layer 7 are arranged such that the discharge cells C of three primary colors, red, green, blue, are arranged side by side in the row direction in order.

Also, a discharge gas including xenon Xe is filled in the discharge space between the front glass substrate 1 and the back glass substrate 5.

In the plasma display device, a selective erasure addressing method is applied in a light emission driving sequence as shown in FIG. 9, where an addressing stage is executed in an addressing period W, and a sustain stage is executed in a sustain period I in each of sub-fields SF1-SFN within a display period of one field (one frame). Also, only in the first sub-field SF1, a reset stage is executed in a reset period R prior to the addressing period W.

In the sustain period after the end of the addressing period W in each of the sub-fields SF1-SFN, before first sustain pulses IP_{X}, IP_{Y} are applied to the row electrodes X₁-Xₙ and row electrodes Y₁-Yₙ, a first wall charge adjusting pulse is applied to the row electrodes X₁-Xₙ, and simultaneously a second wall charge adjusting pulse is applied to the row electrodes Y₁-Yₙ.

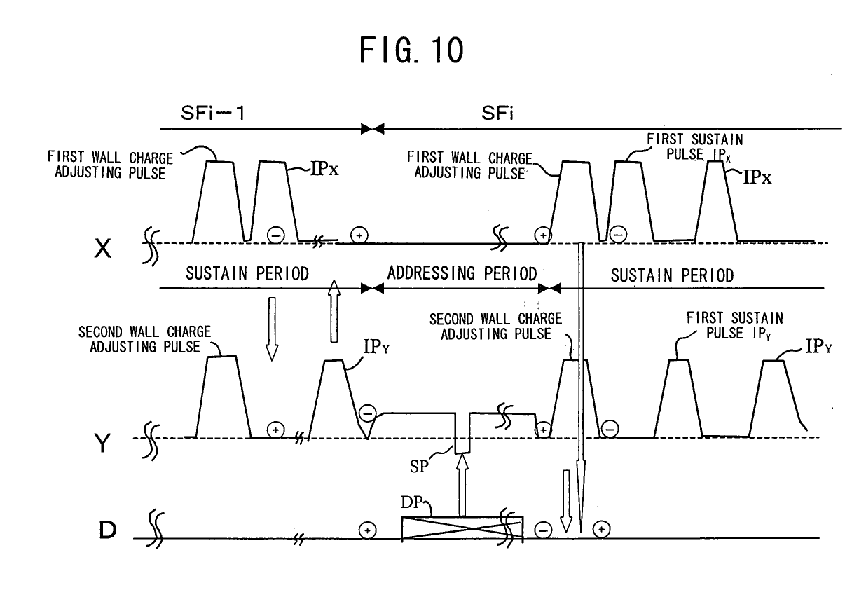

FIG. 10 shows application times at which a variety of driving pulses are applied to the column electrode D and row electrodes X, Y of one discharge cell of the PDP 50, and a change in charge on each period in the sustain period of SFi-1 and the addressing period and sustain period of SFi extracted from the sub-fields SF1-SFN.

At the beginning of each sustain period of the sub-fields SFi-1 and SFi, the first wall charge adjusting pulse is applied to the row electrode X, and simultaneously the second wall charge adjusting pulse is applied to the row electrode Y. In this way, only in those discharge cells in which a selective erasure discharge has occurred in the preceding addressing period, such as the sub-field SFi, a discharge current flows between the row electrode pair X, Y and the column electrode in a direction as shown by an arrow in FIG. 10 to cause each discharge. Therefore, a negative wall charge − is formed on each of the row electrode X and row electrode Y, while a positive wall charge + is formed on the column electrode D. In other words, the polarities of the wall charges on the row electrode X, row electrode Y, and column electrode D at the end of the addressing period of the sub-field SFi reverse by the application of the first wall charge adjusting pulse and second wall charge adjusting pulse. With the polarities which have thus reversed, even if the first sustain pulse is subsequently applied to the row electrode pair X, Y, an erroneous discharge is prevented from occurring between the row electrode X or Y and the column electrode D, thus avoiding a discharge cell which has been set to an “unlit cell” in the addressing period from changing to a “lit cell.”

In a discharge cell in which no selective erasure discharge occurs in the addressing period of the sub-field SF1, the polarity of the wall charge on each of the row electrode pairs and column electrode remains in the same state as that at the end of the sustain period of the sub-field SFi-1, so that the set “lit cell” state is maintained. Therefore, even if the first and second wall charge adjusting pulses are applied in the sustain period of the sub-field SFi, no discharge occurs between the row electrodes and the column electrode, and with subsequent application of each of the first sustain pulses IP_{X}, IP_{Y}, a sustain discharge occurs on a separate basis, and subsequently, sustain discharge light emission is repeated each time the sustain pulses are applied.

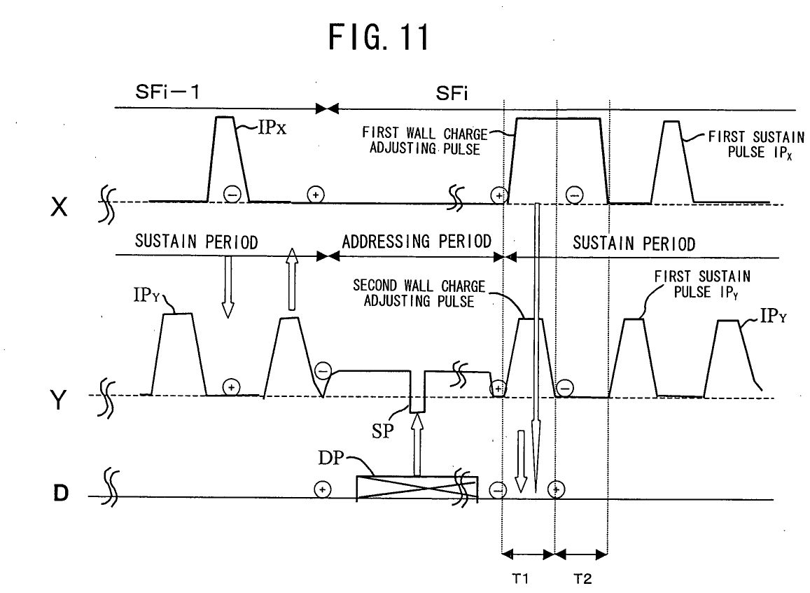

FIG. 11 shows application times at which a variety of driving pulses are applied to the column electrode D and row electrodes X, Y of one discharge cell of the PDP 50 and a change in charge on each electrode in the sustain period of SFi-1 and the addressing period and sustain period of SFi extracted from the sub-fields SF1-SFN in another embodiment.

In the embodiment shown in FIG. 11, the first wall charge adjusting pulse is started to be applied to the row electrode X, and simultaneously the second wall charge adjusting pulse is started to be applied to the row electrode Y at the beginning of each sustain period of the sub-fields, however, the first wall charge adjusting pulse has a pulse width larger than the pulse width of the second wall charge adjusting pulse. Specifically, as shown in the sub-field SFi in FIG. 11, the first wall charge adjusting pulse is applied for a period T1+T2, while the second wall charge adjusting pulse is applied for a period T1. In this way, in the addressing period immediately before the sustain period, only in a discharge cell in which a selective erasure discharge has occurred, a discharge current flows between the row electrode pair X, Y and the column electrode in a direction as indicated by an arrow in FIG. 11 to produce each discharge within the period in which the first and second wall charge adjusting pulses are both applied. Therefore, at the end of the period T1, a negative wall charge − is formed on each of the row electrode X and row electrode Y, while a positive wall charge + is formed on the column electrode D. Subsequently, even if the first sustain pulse is applied to the row electrode pair X, Y, an erroneous discharge is prevented from occurring between the row electrode X or Y and the column electrode D, so that a discharge cell which has been set to an “unlit cell” in the addressing period is avoided from changing to a “lit cell.”

In a discharge cell in which no selective erasure discharge occurs in the addressing period of the sub-field SFi, the polarity of the wall charge on each of the row electrode pair and column electrode is in the same state in the period T1 in which the first and second wall charge adjusting pulses are being applied as that at the end of the sustain period in the sub-field SFi-1, so that the set “lit cell” state is continued. Therefore, even if the first and second wall charge adjusting pulses are both applied in the sustain period of the sub-field SFi, no discharge occurs between the row electrodes and the column electrode, and with subsequent application of each of the first sustain pulses IP_{X}, IP_{Y}, a sustain discharge occurs on a separate basis, and subsequently, sustain discharge light emission is repeated each time the sustain pulses are applied.

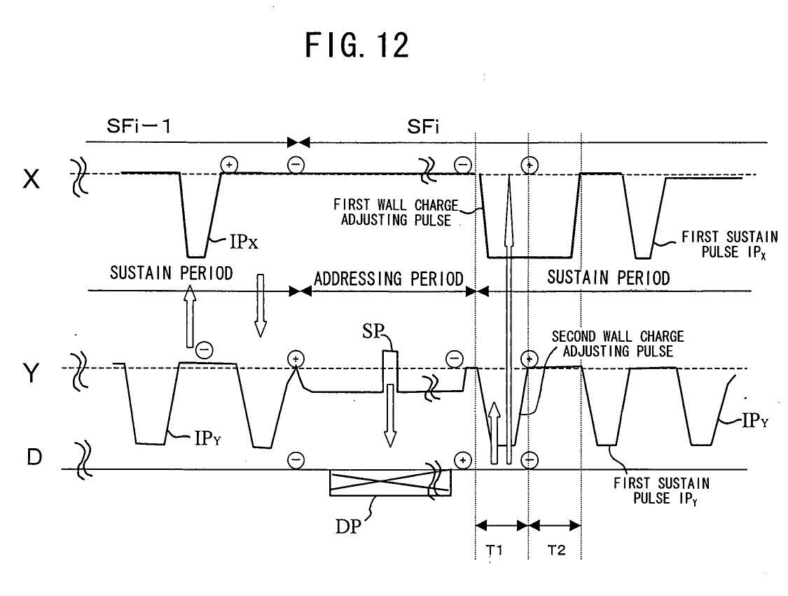

FIG. 12 shows application times at which a variety of driving pulses are applied to the column electrode D and row electrodes X, Y of one discharge cell of the PDP 50, and a change in charge in each electrode in the sustain period of SFi-1 and the addressing period and sustain period in SFi from the sub-fields SF1-SFn in a further embodiment. In this embodiment, the polarity of each driving pulse in FIG. 11 is reverse to that in FIG. 12.

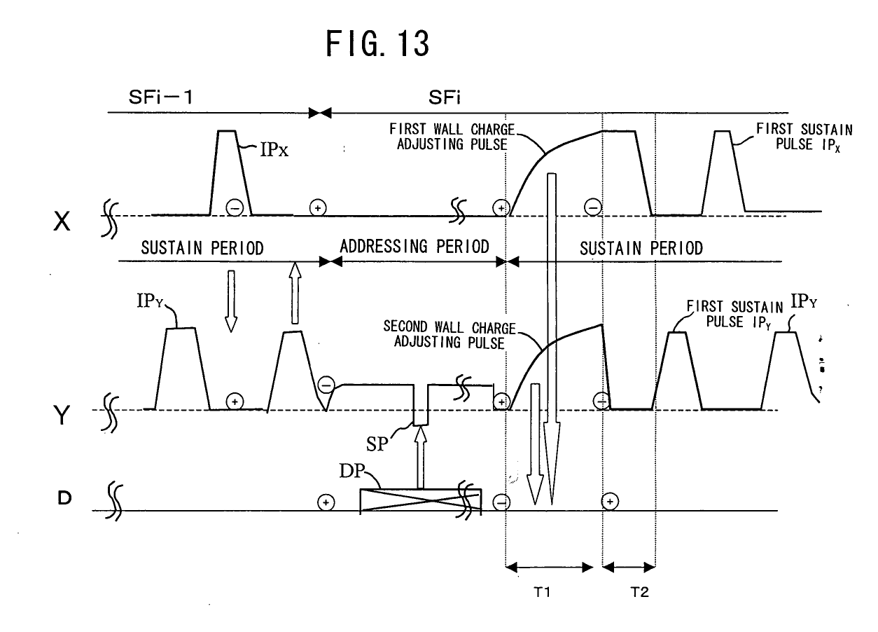

FIG. 13 shows application times at which a variety of driving pulses are applied to the column electrode D and row electrodes X, Y of one discharge cell of the PDP 50, and a change in charge in each electrode in the sustain period of SFi-1 and the addressing period and sustain period in SFi from the sub-fields SF1-SFn in a yet further embodiment. In the embodiment shown in FIG. 13, at the beginning of each sustain period of the sub-fields, the first wall charge adjusting pulse is started to be applied to the row electrode X, and simultaneously, the second wall charge adjusting pulse is started to be applied to the row electrode Y, but each of the first and second wall charge adjusting pulses is modified to more slowly rise. In other words, the first and second wall charge adjusting pulses shown in FIG. 13 rise with a longer time constant than the first and second wall charge adjusting pulses shown in FIGS. 10-12. Also, as shown in the sub-field SFi in FIG. 13, the first wall charge adjusting pulse is applied for a period T1+T2, while the second wall charge adjusting pulse is applied for a period T1.

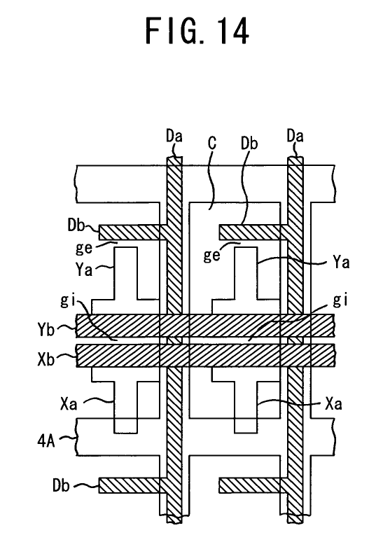

The PDP 50 is not limited to the panel in the structure shown in FIGS. 5 to 8, but may be a panel in a structure as shown in FIG. 14, by way of example. In the panel shown in FIG. 14, each of the bus electrodes Xb, Yb of the row electrode pair (X, Y) are arranged in parallel at the positions of the wider ends of the transparent electrodes Xa, Ya, and the bus electrodes Xb, Yb form a sustain discharge gap gi within the discharge cell C. The column electrode discharge portion Db projecting from the body Da of the column electrode D form a selective discharge gap ge between a proximal end opposite to the wide end of the transparent electrode Ya.

Also, the PDP 50 may be a panel which has one electrode (row electrode) of the row electrode pair and the column electrode D on the front glass substrate, and the other row electrode (row electrode X) of the row electrode pair on the back substrate, and performs a sustain discharge with an opposite discharge.

The embodiment described above employs a one-reset, one-selective erasure addressing method which divides one field into a plurality of sub-fields, where all discharge cells are set to a lit cell state prior to the addressing period only in the first sub-field, and an erasure discharge is selectively produced in accordance with pixel data in the addressing period of one of the sub-fields to keep the sub-field in the lit state until an erasure discharge occurs. In this addressing method, the display can be made in N+1 halftone levels with N sub-fields. The present invention is not limited to this one-reset, one-selective erasure addressing method, but can be applied to a sequence which involves setting all discharge cells once in a lit state in a reset stage in each of the sub-fields, selectively producing an erasure discharge in accordance with pixel data in the subsequent addressing stage, and displaying in 2N halftone levels with N sub-fields.

As described above, according to the present invention, the wall charge adjusting pulses having the same polarity as the sustain pulse are simultaneously applied to the respective row electrodes in pair for a predetermined period after the addressing period terminates and before the sustain period starts in each sub-field, so that even if the first sustain pulse is subsequently applied to the row electrode pair, an erroneous discharge is prevented from occurring between the row electrodes and the column electrode, thus avoiding a discharge cell which has been set to an unlit cell in the addressing period from changing to a lit cell.

This application is based on Japanese Patent Application No. 2005-079447 which is hereby incorporated by reference.

What is claimed is:

1. A method for driving a plasma display panel in accordance with an image signal, said plasma display panel having a pair of substrates opposing across a discharge space, a plurality of row electrode pairs corresponding to display lines and extending in a row direction and a plurality of column electrodes disposed between said pair of substrates, to respectively form discharge cells in portions of the discharge space opposing regions surrounded by row electrodes constituting the respective row electrode pairs and the column electrodes adjacent to each other, at least one of the row electrodes constituting each of said row electrode pairs and each of said column electrodes being formed on one of said pair of substrates, wherein:
one field display period of the image signal is divided into a plurality of sub-fields, said method comprising the steps of:
executing in each of said sub-fields,
an addressing stage for sequentially applying a scan pulse to one row electrodes of said row electrode pairs, and applying pixel data pulses corresponding to the image signal to said column electrodes to produce a selective erasure discharge for setting each of said discharge cells to one of a lit cell state and an unlit cell state, and
a sustain stage for applying a sustain pulse to the row electrodes constituting each of said row electrode pairs a number of times corresponding to a weight for the sub-field to produce a sustain discharge only in the discharge cell in the lit cell state; and
simultaneously applying wall charge adjusting pulses having a same polarity as the sustain pulse to said row electrodes formed in pair for a predetermined period in each of the sub-fields after the addressing stage terminates and before the sustain stage starts.

2. A method for driving a plasma display panel according to claim 1, wherein a discharge occurs between each of said row electrodes and said column electrode upon the simultaneous application of the wall charge adjusting pulses only in discharge cells in which the selective erasure discharge has been occurred in the addressing stage, causing the polarity of a wall charge to reverse on each of said row electrodes and said column electrode.

3. A method for driving a plasma display panel according to claim 1, wherein the wall charge adjusting pulse applied to one row electrode of said row electrode pair has a pulse width which is set longer than the pulse width of the wall charge adjusting pulse applied to another of said row electrode pair.

4. A method for driving a plasma display panel according to claim 3, wherein a sustain discharge is produced only in each discharge cell which is set to the lit discharge cell in the addressing stage for a duration in which the wall charge adjusting pulse applied to the other of said row electrode pair is remaining after the wall charge adjusting pulse applied to the one of said row electrode pair terminates.

5. A method for driving a plasma display panel according to claim 1, where said wall charge adjusting pulses have a slow rising period as compared with the sustain pulse.

6. A method for driving a plasma display panel according to claim 1, wherein said one substrate is a front substrate which is on a display plane side.

7. A method for driving a plasma display panel according to claim 1, wherein each of the row electrodes constituting said row electrode pairs and said column electrodes are formed on the front substrate side.

8. A method for driving a plasma display panel according to claim 1, wherein one electrode of each of said row electrode pairs applied with the scan pulse, and said column electrodes are formed on the front substrate side, and the other row electrode of each of said row electrode pairs is formed on the other substrate which opposes across the discharge space.
